(19) United States
(12) Patent Application Publication
(10) Pub. No.: US 2024/0373827 A1
(43) Pub. Date: Nov. 14, 2024

(54) DEVICE FOR LIFTING FRAMES OF A MAGAZINE HIVE FOR BEEKEEPING

(71) Applicant: Thomas SENFT, Bromberg (AT)

(72) Inventor: Thomas SENFT, Bromberg (AT)

(21) Appl. No.: 18/692,683

(22) PCT Filed: Aug. 9, 2022
(86) PCT No.: PCT/EP2022/072366

§ 371 Date: Mar. 15, 2024

(30) Foreign Application Priority Data
Sep. 29, 2021 (EP) 21199776.2

(51) Int. Cl. A01K 47/06

(52) U.S. Cl. CPC A01K 47/06

(57) ABSTRACT

Device for lifting frames of a magazine hive for beekeeping, each frame having an approximately horizontal bar on opposite sides of the magazine hive, wherein the device has two pairs of support elements each having an upper and a lower support element, wherein each pair may be arranged on one side of the magazine hive and the support elements may be inserted between the strips of two frames, wherein in each pair the support elements are connected via a scissor mechanism, and wherein the upper support element of each pair is formed by a rail which is divided into at least two parts which are displaceable relative to one another in the longitudinal direction of the rail, one part of which may be placed against one of the strips from below and the other part is connected to the scissor mechanism.

### CROSS-REFERENCE TO RELATED APPLICATION/S

This application is a National Phase application of International Application No. PCT/EP2022/072366 filed Aug. 9, 2022, which claims priority to the European Patent Application No. 21 199 776.2 filed Sep. 29, 2021, the disclosures of which are incorporated herein by reference in their entireties.

### TECHNICAL FIELD

The present disclosed subject matter relates to a lifting device for processing beehives.

### BACKGROUND ART

In traditional beekeeping, bees are kept in magazine hives. Magazine hives consist of one or more frames stacked on top of each other. Frames are boxes that are open at the top and bottom and into which wooden frames with honeycombs may be hung. The brood chamber frames with the brood chamber are located in the lower region of the beehive. Honey frames are placed above the brood chamber to store the honey.

The first honey frame is usually placed on the brood chamber frame(s) from the time of cherry blossom onwards. Depending on the nectar supply and the strength of the bee colony, one to four honey frames are usually placed on one or two brood frames. The weight of a full honey frame is approximately 20 kg to 40 kg, depending on the frame size. This means that—depending on the amount of work carried out in the magazine hive—the beekeeper has to lift a corresponding number of heavy frames from the stack and put them back on again after processing each time the bee colony is worked on.

Interventions in the bee colony, where frames have to be removed from the stack forming the magazine hive, are for example:
cutting the drone frame,
checking the feed reserves,
swarm control,
with two brood frames: checking the bottom frame,
removing a brood or forming a subsidiary brood,
inserting the bee escape before the honey harvest,
inserting or removing barrier grilles,
queening a queen, etc.

To lift or remove frames from the magazine hive, either stationary cranes, e.g. with trolleys above the hives, or mobile frame lifters similar to forklift trucks are currently used. The former variant is complex to install, the latter is extremely heavy and unwieldy, especially if the frame lifter has to be moved to different hives in the field.

The document RU 182 674 U1 discloses a mobile frame lifter with a lower frame which is supported on side strips of a lower frame and via a base on the floor, and a lever-operated lifting carriage which is mounted movably on the lower frame. To expose the lower frame, the lifting carriage is moved under the side strips of an upper frame, operated to lift the frames above the lifting carriage and moved on the lower frame towards the beekeeper with the frames lifted. This frame lifter is bulky to transport, cumbersome to handle and requires the beekeeper to walk long distances to reach the exposed frame.

### BRIEF SUMMARY

The objective of the disclosed subject matter is to create a lifting device for frames of a magazine hive which is particularly easy to transport and handle and enables effortless access to the magazine hive.

This objective is achieved with a device for lifting frames of a magazine hive for bee-keeping, which frames each have an approximately horizontal, projecting strip on two opposite sides of the magazine hive, wherein the device according to the disclosed subject matter has two pairs of support elements, each with an upper and a lower support element, wherein each pair may be arranged on one side of the magazine hive and the support elements of a pair may be inserted between the strips of two frames, and wherein in each pair the support elements are connected via a scissor mechanism which may be spread apart by means of a toggle lever consisting of two lever elements hinged to one another.

The frame lifter of the disclosed subject matter has a particularly simple structure and is reduced to the essential elements for lifting one or more frames, so that it is particularly lightweight and space-saving. It may therefore be transported quickly and easily to a wide variety of beehives, for example in the boot of a car, and enables simple, effortless handling of the frames on site.

In use, the support elements on each side of the magazine hive are inserted between the strips of an upper and a lower frame and then—by spreading the support elements apart by means of the scissor mechanisms and toggle levers—allow easy access to the stack, for example to insert or remove a frame into or from the stack.

Optionally, the lifting elements of the two toggle levers are connected to each other via a common handle that grips the magazine hive transversely, so that the lifting device may be operated with just one hand after insertion between the strips. The handle connecting the lifting elements of the two toggle levers also provides additional mechanical stabilisation of the device.

According to a further optional feature of the disclosed subject matter, the toggle levers are embodied in such a way that they may be overstretched in order, in their overstretched position, to lock the scissor mechanisms in the spread-apart position. This results in a very simple, self-locking mechanical fixation of the device in the raised position.

According to the disclosed subject matter, the upper support element of each pair is formed by a rail which may be placed against a strip from below and which is divided into at least two parts which are displaceable relative to one another in the longitudinal direction of the rail, one part of which may be placed against a strip and the other part of which is connected to the scissor mechanism. This results in a secure and stable support for the raised frame(s). Furthermore, the raised frame(s) may be moved horizontally in the manner of a drawer in relation to the remaining stack of frames below. The beekeeper may thus work on a frame directly from above. This means it may be worked on particularly easily and conveniently.

According to a further optional feature of the disclosed subject matter, the upper support elements may be connected to one another via a strut that transversely runs around the magazine hive in order to further stabilise the device.

The lower support element of each pair may also be configured in a variety of ways, in the simplest case by the lower bearing points of the scissor mechanism itself. Optionally, however, the lower support element of each pair is formed by a leg of a U-shaped bracket that may be placed on a strip and which transversely runs around the magazine hive. On the one hand, this results in good force transmission to the lower frame and, on the other hand, additional mechanical stabilisation of the device via the transversely running bracket.

Optionally, each scissor mechanism has two scissor arms articulated crosswise to each other, of which the first scissor arm is hinged with one end to the upper support element and may roll with the other end via a roller on the lower support element or on a strip and the second scissor arm rolls with one end via a roller on the upper support element and is hinged with the other end to the lower support element. The scissor mechanisms are thus reduced to the bare essentials and are therefore very lightweight. If the lower end of the first scissor arm rolls directly on the strip of the lower frame, the length of the lower support element, for example the leg of the U-shaped bracket, may be shortened, thus saving even more weight.

In an alternative variant, the scissor mechanisms may also be embodied as crossed crank arms. For this purpose, each scissor mechanism has two scissor arms hinged to each other in a crossed arrangement, of which the first scissor arm is hinged at one end to the upper support element and at the other end to the lower support element via a rocker, and the second scissor arm is hinged at one end to the upper support element via a rocker and at the other end to the lower support element.

The device of the disclosed subject matter may be used for frames that are already equipped with side strips. Alternatively, the device itself may also comprise a set of strips that may be mounted on the frames, said strips being mounted on all frames that do not have such strips as standard before the device is put into operation.

According to an optional feature of the disclosed subject matter, the strips of the device according to the disclosed subject matter rise on their underside in the direction of the frame, so that the upper support elements or rails engage in the lower-side undercuts of the strips created in this way and are unable to slip off.

Optionally, each strip also has a recess on its upper side for the engagement of a lower-side projection of the respective lower support element, which prevents the device from slipping off the lower frame, in particular when the handle is actuated. The recess may optionally also be provided with at least one drainage hole passing through the strip.

### BRIEF DESCRIPTION OF THE DRAWINGS/FIGURES

The disclosed subject matter is explained in greater detail below with reference to exemplary embodiments shown in the accompanying drawings, in which:

FIGS. 1 to 3 show the device of the disclosed subject matter in three different operating positions on a magazine hive in a perspective view from above;

FIG. 4 shows a perspective view from above of the device of the disclosed subject matter in the operating position of FIG. 2;

FIG. 5 shows a cross-section through one of the strips of the frames of the magazine hive

of FIGS. 1-3; and

FIG. 6 shows a side view of a further embodiment of the device of the disclosed subject matter.

### DETAILED DESCRIPTION

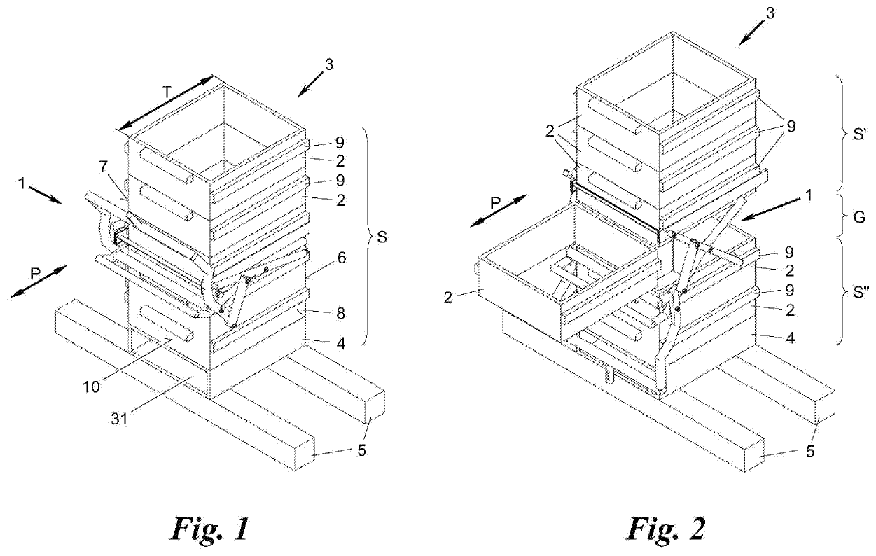

FIGS. 1-4 show a device 1 for lifting one or more frames 2, which are stacked on top of each other as a stack S to form a magazine hive 3, as used in beekeeping. The magazine hive 3 generally also has a base 4, on which the lowest frame 2 of the stack S is placed, and a lid (not shown), which covers the uppermost frame 2 of the stack S. The magazine hive 3 is placed on a substructure consisting of, for example, two squared timbers 5 or a pallet.

Each frame 2 has approximately the shape of a flat box, usually made of wood, which is open at the top and bottom and into which wooden frames with honeycombs (not shown) may be hung, as is known to a person skilled in the art. The lowest frame(s) 2 is/are usually operated as a brood chamber, wherein the lowest frame 2 or the bottom 4 is provided with a flight hole at the front side 6 of the magazine hive 3 (shown at the rear in FIGS. 1-3 and thus not visible). The bottom 4 may have an inspection opening 31 on the rear side 10 of the magazine hive 3 (shown at the front in FIGS. 1-3), which may be closed, for example, with a flap (not shown).

Barrier grilles, intermediate levels and bee escapes (not shown) may also be inserted between two frames 2, for example between brood chamber and honey chamber frames 2. Other types of frames 2 may also be used in the stack S of the magazine hive 3, for example feed frames, etc.

For the use of the lifting device 1, the frames 2 are each provided with (at least) one approximately horizontal, projecting strip 9 on two opposite sides 7, 8 of the magazine hive 3. The strips 9 run optionally-but not necessarily-over the entire depth T of a frame 2. The device 1 is inserted between the strips 9 of two frames 2 lying directly on top of each other in the stack S-or with frames 2 disposed between them-while extending around the magazine hive 3, see FIG. 1, and then the strips 9 are spread apart by means of the device 1 and thus the upper frame 2 belonging to the upper strips 9 and all frames 2 possibly stacked further on top of it are lifted; see FIG. 2.

This means that the gap G created between the lifted part S′ of stack S of frames 2 and the remaining part S″ of the stack S may be used to reach into it and thus process the uppermost frame 2 of the remaining part S″, for example to inspect or replace the frames hung in it.

The resulting gap G may also be used to insert a further frame 2 between two directly stacked frames 2, as shown in the sequence of FIGS. 1 and 2. Or, for example, the middle frame 2 of a group of three frames 2 may be removed and processed when the device 1 is inserted between the strips 9 of the lowest and highest frame 2 of the group of three, as shown in FIG. 2 alone.

For insertion between the strips 9 of an upper and a lower frame 2, the device 1 is substantially U-shaped when viewed from above (see FIG. 4) so that it may be inserted, for example, from the rear side 10 of the magazine hive 3 onto the magazine hive 3 in the direction of arrow P between the strips 9 and pulled out again from these.

According to FIG. 4, the device 1 has two pairs of support elements 11, 12, namely a left pair consisting of an upper support element 11 and a lower support element 12 and a right pair consisting of an upper support element 11 and a lower support element 12. Each pair 11, 12 comes to rest on a side 7, 8 of the magazine hive 3 in the operating position (FIGS. 1-3), wherein the support elements 11, 12 of a pair are inserted between the strips 9 of two frames 2 lying directly-or with frames 2 disposed between them-one above the other.

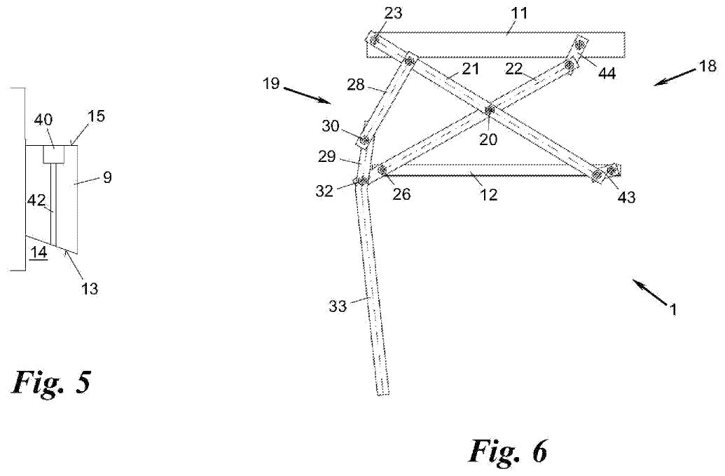

The upper support elements 11 are, for example, rails that run along the entire length of the strips 9. As shown in FIG. 5, the undersides 13 of the strips 9 may rise at an angle (or in steps, not shown) towards the frame 2, resulting in a lower-side undercut 14 between the strip 9 and the frame 2. The respective upper support element 11 (here: the rail) may engage in the undercut 14. For this purpose, the upper side of the support element 11 may be configured to complement the lower side 13.

The lower support elements 12 could likewise be rails that come to rest on the upper side 15 of the respective strip 9 and run, for example, over the entire length of the strip 9. In the example shown, however, the lower support elements 12 are short legs of a U-shaped bracket 16, which transversely spans, i.e. runs around, the magazine hive 3 on the rear side 10.

The upper support elements 11 may be connected to each other in a similar way via a strut 17 on the side 10 of the magazine hive 3. Bracket 16 and/or strut 17 may also be omitted, at the cost of somewhat reduced stability, but with the advantage of reduced weight.

To spread the support elements 11, 12 vertically apart and thus lift the upper frame/s 2 from the lower frame/s, the support elements 11, 12 in each pair are connected to each other via a scissor mechanism 18, and the scissor mechanisms 18 may each be spread apart by means of a toggle lever 19.

The scissor mechanisms 18 may be constructed from any number of scissor arms, even in the manner of lazy tongs. In the illustrated embodiment with the lowest weight, each scissor mechanism 18 has only two scissor arms 21, 22 hinged together in the shape of an “X” at 20. The upper end of the first scissor arm 21 is pivotably hinged to the upper support element 11 at 23, namely (here: ) to the end of the support element 11 facing the bracket 16. The lower end of the first scissor arm 21 rolls over a roller 24 on the upper side 15 of a lower strip 9 or—if the lower support element 12 extends, for example, over the entire length of the strip 9—on the lower support element 12. In the latter case, the lower end of the first scissor arm 21 may also be slidingly guided on the lower support element 12 without roller 24.

The upper end of the second scissor arm 22 is slidingly guided on the upper support element 11, e.g. in a corresponding sliding guide, or rolls on the upper support element 11 with the aid of a roller 25. The lower end of the second scissor arm 22 is pivotably articulated at 26 to the lower support element 12. Optionally, the second scissor arm 22 could also roll directly on the underside 13 of an upper strip 9 by means of the roller 25 if the upper support element 11 is just as short as the lower support element 12, for example.

For additional stabilisation, the two second scissor arms 22 may optionally be connected to each other via a further U-shaped bracket 27 that runs around the side 10 of the magazine hive 3. If desired, the ends of the two first scissor arms 21 facing the side 10 could also be connected to each other by a similar bracket (not shown).

The toggle levers 19 for actuating the scissor mechanisms 18 are each composed of two lever elements 28, 29, one end of which is pivotably articulated to one another at 30 and the other end of which engages either on one of the support elements 11, 12 or (here: ) on one of the scissor arms 21, 22 remote from their mutual articulation 20.

One or more of the lever elements 28, 29 may be equipped with a handle or extended to form such a handle. In the example shown, each lever element 29 is extended beyond its articulation 32 on the respective scissor arm 22 to form a two-armed lever, i.e. has a handle 33 opposite its articulation 30 on the other lever element 28 with respect to the articulation 32. The handles 33 of both lever elements 29 may optionally be connected to each other via a rod 34 to form a handle 35, which transversely grips the magazine hive 3 at its rear side 10. As may be seen from the sequence of FIGS. 1 and 2, the toggle levers 19 may thus be stretched by pivoting the handle 35 downwards, thereby spreading the scissor mechanisms 18 in order to lift the upper frame(s) 2 out of the stack S. Optionally, the toggle levers 19 may be overstretched in order, in their overstretched position, to lock the scissor mechanisms 18 in the spread-apart position.

The handle 35 may additionally be provided with an extension 36, which may be held in the downward-swivelled position of the handle 35 (FIG. 2), for example with the foot, or temporarily fixed to the floor 4 or the squared timbers 5 by means of a corresponding locking mechanism (not shown).

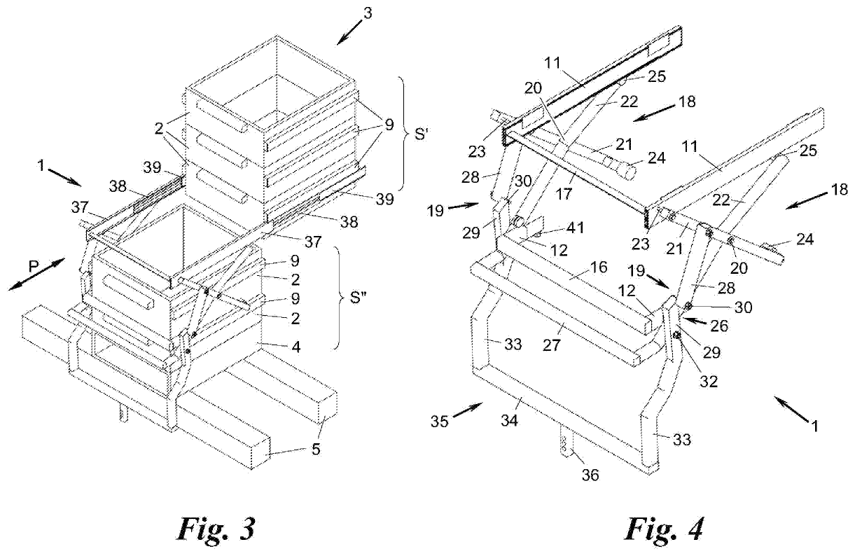

FIG. 3 shows a further operating position of the device 1, which may be achieved with an optional embodiment of the upper support elements or rails 11. For this purpose, the support elements or rails 11 are divided into at least two parts 37, 38, 39 which are displaceable relative to one another in the longitudinal direction of the rail or the direction of the arrow P. The uppermost or outermost part 39 is configured for gripping an upper strip 9 and the lowermost or innermost part 37 is connected to the scissor mechanism 18. As a result, in the raised position of the upper stacking part S′ (FIG. 2), the raised frame(s) 2 may be displaced in the direction of arrow P transversely to the remaining stacking part S″ of frames 2 below by moving the part 39 relative to the part 37; see FIG. 3. The uppermost frame 2 of the remaining stacking part S″, which is thus exposed, may now be processed from above without having to be removed from the stack S.

As shown in FIG. 5, one or more recesses 40 for the engagement of projections 41 (FIG. 4) of the lower support elements 12 may be provided on the upper sides 15 of the strips 9. This secures the device 1 against slipping in the direction of arrow P, in particular when the handle 35 is pivoted. In order to prevent water from standing in the recesses 40, these may be provided with drainage holes 42 passing through the strip 9.

FIG. 6 shows an alternative embodiment of the scissor mechanisms 18. The lower end of the first scissor arm 21 is articulated here via a rocker 43 to the end of the lower support element 12 opposite the articulation 26 of the second scissor arm 22, and the upper end of the second scissor arm 22 is articulated via a rocker 44 to the end of the upper support element 11 opposite the articulation 23 of the first scissor arm 21. The other elements of the scissor mechanisms 18 and the toggle levers 19 are the same as in the embodiment of FIGS. 1-4.

The disclosed subject matter is not limited to the embodiments presented, but includes all variants, modifications and combinations thereof which fall within the scope of the appended claims.

1. A device for lifting frames of a magazine hive for beekeeping, which frames each have an approximately horizontal, projecting strip on two opposite sides of the magazine hive, comprising
two pairs of support elements each having an upper and a lower support element, wherein each pair may be arranged on one side of the magazine hive and the support elements of a pair may be inserted between the strips of two frames,
wherein in each pair the support elements are connected via a scissor mechanism which may be spread apart by means of a toggle lever consisting of two lever elements articulated to one another, and
wherein the upper support element of each pair is formed by a rail which is divided into at least two parts which are displaceable relative to one another in the longitudinal direction of the rail, one part of which may be placed against one of the strips from below and the other part is connected to the scissor mechanism.

2. The device according to claim 1, wherein the respective lever elements of the two toggle levers are connected to one another via a common handle which transversely runs around the magazine hive.

3. The device according to claim 1, wherein each toggle levers may be overstretched in order, in an overstretched position, to lock the scissor mechanisms in the spread-apart position.

4. The device according to claim 1, wherein the upper support elements of the two pairs are connected to one another via a strut which transversely runs around the magazine hive.

5. The device according to claim 1, wherein the lower supporting element of each pair is formed by a respective leg of a U-shaped bracket which may be placed on a strip and which transversely runs around the magazine hive.

6. The device according to claim 1, wherein each scissor mechanism has two scissor arms articulated crosswise to one another, of which a first scissor arm is articulated with one end on the upper support element and may roll with the other end via a roller on the lower support element or on a strip, and a second scissor arm rolls with one end via a roller on the upper support element and is articulated with the other end on the lower support element.

7. The device according to claim 1, wherein each scissor mechanism has two scissor arms articulated crosswise to one another, of which a first scissor arm is articulated with one end to the upper support element and with the other end via a rocker to the lower support element and a second scissor arm is articulated with one end via a rocker to the upper support element and with the other end to the lower support element.

8. The device according to claim 1, further comprising a set of strips which may be mounted on the frames and which each rise on an underside in the direction of the frame.

9. The device according to claim 8, wherein each strip has a recess on an upper side thereof for the engagement of a lower-side projection of the respective lower support element.

10. The device according to claim 9, wherein the recess is provided with at least one drainage hole passing through the strip.
